(19) United States
(12) Patent Application Publication
(10) Pub. No.: US 2020/0247681 A1
(43) Pub. Date: Aug. 6, 2020

(54) SUITABLE REAGENT FOR THE TREATMENT OF HIGH-SULPHATE WATERS

(71) Applicant: SMR TECHNOLOGIES LIMITED, West Midlands (GB)

(72) Inventor: Richard George PAXTON, West Midlands (GB)

(21) Appl. No.: 16/648,939

(22) PCT Filed: Sep. 12, 2018
(86) PCT No.: PCT/IB2018/056964

§ 371 Date: Mar. 19, 2020

(30) Foreign Application Priority Data
Sep. 20, 2017 (NL) 2019582

(51) Int. Cl. C01F 7/16; C02F 1/52

(52) U.S. Cl. CPC C01F 7/164; C02F 2101/101; C02F 1/5245

(57) ABSTRACT

The present invention relates to the manufacture of a chemical reagent whose principal active constituent comprises hydrated metastable forms of CAH₁₀ and C₂AH₈ in aqueous suspension, and for use of the reagent within other processes where an aqueous suspension of precipitated calcium aluminate is required. The present invention further relates to the use of one or more particle segregation stages to assist the chemical reaction processes that are involved.

### FIELD OF APPLICATION OF THE INVENTION

The present invention relates to the manufacture of a chemical reagent whose principal active constituent comprises hydrated metastable forms of CAH₁₀ and C₂AH₈ in aqueous suspension, and for use of the reagent within other processes where an aqueous suspension of precipitated calcium aluminate is required.

### BACKGROUND TO THE INVENTION

Throughout the world, there are many situations where industrial and mining activities create large volumes of process and/or waste waters which contain high concentrations of sulphates. Most of these high-sulphate waters also contain substantial concentrations of other multi-valent ions. Also, they frequently have a low pH and can cause substantial environmental problems unless they are treated appropriately.

There are a large number of technologies available for the treatment of these high-sulphate waters and for recovering the water to a quality which is fit for re-use at the site that produced the high-sulphate water, for use by others or for safe discharge into the environment. However, all of these technologies come with associated costs. In addition, these technologies create by-products and process residues. These by-products and process residues are derived from the contaminants which have to be removed from the high-sulphate water as well as from components within the chemical reagents which have to be used within the particular treatment process that is being applied. Also, many of the processes add significant concentrations of one or more mono-valent ions to the product water.

The normal means that are applied to the high-sulphate water in order to create an acceptably low sulphate concentration include ion exchange or membrane-based processes. However, these processes have high capital costs and/or high operating costs. In addition, they frequently suffer from a number of blinding and fouling mechanisms which can result in frequent shut downs for cleaning and to a short operating life for the respective resins and membranes.

An alternative technology is to exploit the very much lower solubility of ettringite and of other calcium alumino-sulphate hydrate compounds. Ettringite and these other calcium alumino-sulphate hydrate compounds have complex crystal structures. These structures are able to include many other ionic components within their crystal lattices, both anions and cations, especially multi-valent anions and cations. Ettringite has the generally accepted formula of: Ca₆Al₂(SO₄)₃(OH)₁₂.26H₂O.

Within the following text, unless specified otherwise, the term ettringite should be interpreted as including both ettringite and the other calcium alumino-sulphate hydrate compounds.

Ettringite crystals require a high pH and sufficient aluminium, as well as the necessary calcium and sulphate in order for them to grow.

As a result of the typically acidic nature and the typically high concentrations of other multi-valent ions within the high-sulphate waters that are often associated with heavy industry and with mining activities, a substantial quantity of neutralising medium has to be added before ettringite can be created. Lime, because of its relatively low price and general availability, is frequently used to supply this neutralising function. Additionally, this input of lime is normally able to provide the necessary calcium input for an effective ettringite based treatment process.

At a high pH (above the pH of its minimum solubility), aluminium exists in solution predominantly as the hydrated and negative ion Al(OH)₄⁻ (the aluminate ion). At low pH (below the pH of its minimum solubility), it exists as a positive ion.

Usually, if the sulphate content of the high-sulphate water is high enough, gypsum is precipitated within a first stage of a treatment process for the water. Typically, the precipitated gypsum is then removed before the water is routed to a second treatment stage. Within this second treatment stage, a water-soluble aluminium reagent is usually added, together with more lime. An example of this treatment process is the CESR Process where the soluble aluminium reagent is a proprietary reagent powder. The process was developed within Eastern Europe and has been widely applied to heavy industry and mining related high-sulphate waters within Europe.

Unfortunately, the proprietary reagent powder typically contains a large proportion of unreactive components and the reactive portion of the aluminium content is often quite slow to dissolve and to therefore become available to the ettringite production process. This leads to long reaction times within the ettringite production portion of the process and therefore to large reactors. It also leads to substantial amounts of unreacted aluminium being present within the process residues. The typically high concentration (often greater than 50%) of unreactive components within the principal reagent also leads to increased transport costs for the reagents to the treatment facility and for the residues away from the treatment facility.

In most of the other situations the aluminium reagent has a prohibitively high price and/or it comes with substantial amounts of associated components (e.g. sodium or chloride). The high reagent cost has led to a number of developments whereby most of the aluminium is recovered from the ettringite product and re-used within the second treatment stage. Depending on the specifics of the particular aluminium recovery process that is applied, it is usual for a large amount of additional residue to be created or for large quantities of mono-valent ions to be added to the product water and/or to one or more of the residue streams.

Once the ettringite that has been produced by the treatment process has been removed from the water (usually by a combination of gravity settlement and filtration) the ettringite can be re-dissolved within a lower pH environment. Some of the existing technologies use sulphuric acid, for example, within the SAVMIN Process, to create and maintain this lower pH environment. Others use hydrochloric acid, or a mixture of sulphuric and hydrochloric acid.

With appropriate pH monitoring and process control, the pH can be maintained at a level which is low enough for the ettringite to dissolve but high enough for the aluminium that is released from the ettringite to be precipitated as aluminium hydroxide. Also, the calcium and the sulphate portion of the ettringite are normally precipitated in the form of gypsum. The mixture has to be separated into a gypsum product or residue and a sufficiently pure aluminium hydroxide for return to the sulphate removal stage within the overall process.

Within the prior art SAVMIN Process, the slow rates of nucleation and crystallisation of gypsum are exploited. The aluminium hydroxide can be made to precipitate rapidly and providing the resultant precipitate is removed promptly from the reaction mixture, there is relatively little gypsum contamination within the aluminium hydroxide. The gypsum is then crystallised within a subsequent stage, where the kinetics of precipitation are normally assisted by a gypsum seeding process using either fresh or recycled gypsum.

Within another prior art process that is being marketed by Veolia (US 2014/0144843) the addition of hydrochloric acid to the separated ettringite creates a solution which contains dissolved calcium chloride. Under these conditions it is possible to increase the solubility of gypsum to the extent that with appropriate control over the content of the mixture, only the aluminium hydroxide is precipitated and the sulphate that is released from the ettringite as it dissolves remains in solution, at least until the aluminium hydroxide has been removed from the solution. This process unfortunately creates a concentrated brine residue which requires disposal and/or it adds a substantial amount of dissolved chloride to the treated water.

Another method for reducing the high operating costs associated with the necessary aluminate input to the formation of ettringite is to create a fresh source of sodium aluminate at or adjacent to the treatment process for the high-sulphate water. Such a process is described within WO 2015/128541. Within this process a source of aluminium hydroxide or hydrated aluminium oxide (usually in the form of gibbsite or bayerite) is reacted with a strong caustic soda (NaOH) solution at temperatures preferably in excess of 90° C. to form a concentrated solution of sodium aluminate. This solution is then used within the ettringite production process. The advantages that are claimed for the reagent that is produced within this process relative to purchased sodium aluminate solution are the somewhat lower cost of the reagent per unit of aluminate and the greater availability of that aluminate to the formation of ettringite within the ettringite production process.

There are three principal forms of hydrated calcium aluminate, which (using cement technology notation) have the formula CAH₁₀, C₂AH₈ and C₃AH₆. CAH₁₀ and C₂AH₈ are the metastable forms and C₃AH₆ is the thermodynamically stable form and also the least soluble form. However, at temperatures below about 50° C., the other two forms are created almost exclusively. Once these metastable forms have been created, they are slowly converted into the thermodynamically stable form. This conversion is very slow at ambient temperatures.

The relative proportions of the CAH₁₀ and the C₂AH₈ forms that are created when hydrated calcium aluminate is precipitated from an aqueous solution are a function of both the temperature and the available reaction time. Below about 15° C., the CAH₁₀ is created almost exclusively. Between about 15° C. and 27° C., both forms can co-exist and above about 27° C., the C₂AH₈ form tends to predominate. Subject to the availability of both Ca and OH within the reaction mixture, CAH₁₀ slowly converts into C₂AH₈ and, very much more slowly, the C₂AH₈ converts into C₃AH₆. The rate of conversion increases with increasing temperature. It is anticipated that increasing levels of pH will favour an increasing proportion of C₂AH₈ relative to CAH₁₀. The hydrates begin to form at a pH of about pH 8 and their rate of formation increases rapidly with increasing pH.

The generally accepted chemical formula for CAH₁₀ is Ca(Al(OH)₄)₂.6H₂O.

The generally accepted chemical formula for C₂AH₈ is Ca₂(Al(OH)₄)₂(OH)₂.3H₂O.

Electro-coagulation is a well-known technique within the waste water treatment industry for, amongst other things, the in-situ creation of a ferric based coagulant for coagulating colloidal and particulate contaminants and thereby rendering them more readily separable from the waste water. This coagulation function is in addition to the ability of ferric hydroxide particles and hydrated ferric oxide particles to combine within themselves and on their surfaces dissolved and colloidal contaminants. This technique requires an electrical current to be passed between a sacrificial iron anode and a corrosion resistant cathode. Typically, surface fouling on the electrodes causes the necessary electrical power consumption to be high and for high corrosion rates on the cathode. Also, large electrode surface areas are necessary and/or poor electrical efficiency is incurred when the contaminant concentration levels have to be reduced to those that are typically necessary for the safe re-use of the treated water.

Within the USSR an alternative technique called Galvano-coagulation has been developed and widely utilised. Typically, the sacrificial anode is created from shredded iron or steel scrap and the cathode consists of “carbon particles”. In most of the published applications of Galvano-coagulation, the “carbon particles” have consisted of coal or coke particles, but graphite and other particulate forms of elemental carbon can be included within the definition of “carbon particles”. The metal particles and the carbon particles are mixed together within an electrolyte (usually the waste water itself) and at their touch points they are able to create an electrical contact which completes a galvanic corrosion circuit. The mixing process is often carried out within a pulsed column or by tumbling the particles within a rotating vessel. This mixing process is preferably accompanied by a plentiful supply of air. Alternative means for creating an oxidising environment can also be used. As a result of the galvanic corrosion and the oxidising conditions, ferric ions are created from the iron and steel particles. The agitation causes the particles to abrade each other, thereby scraping off any accumulations of unwanted fouling. The process is therefore able to utilise low cost materials within low cost equipment and does not require electrical power other than for the relatively gentle mixing that is required.

A similar arrangement has been utilised within a process for the removal of fluoride ions from waste water. In this instance, shredded aluminium was corroded in the presence of carbon particles in order to create an in-situ precipitate of aluminium hydroxide. When aluminium hydroxide is precipitated, fluoride ions are able to substitute hydroxide ions within the lattice structure of the precipitating particles.

In one reported example of Galvano coagulation, it was found that when a proportion of the precipitated solids were recycled back into the mixing mixture of contaminated water and cathodic and anodic particles, both the rate of depletion of the anodic material and the rate of removal of the contaminant were increased substantially. It was apparent that at least a proportion of the precipitated solids were able to supplement or assist the role of the carbon particles.

For most of the ettringite based processes for the removal of sulphates from sulphate containing waters, there is a requirement for the addition of a suitable aluminium containing reagent to the ettringite formation stage(s) within these treatment processes and within the alternative ettringite based treatment processes. As noted above, for most situations, the aluminium should preferably be added without also adding an additional soluble component such as sodium or chloride (such as is the case with WO 2014/033361, WO 2015/128541 and US 2014/0144843) and without also adding substantial amounts of other contaminants (such as is the case within the CESR Process). Further and preferably, this additional source of aluminium should result in a lower overall process cost relative to the alternative options per unit of aluminium added.

### OBJECT OF THE INVENTION

Accordingly, it is an object of the present invention to provide a process within which a suitable reagent can be created for supplying the necessary input of aluminium to the ettringite production stage within ettringite based treatment processes for high-sulphate waters or for use within other situations where a reagent consisting of an aqueous suspension of calcium aluminate is required and where that reagent will not cause significant amounts of mono-valent or other contaminants to be added to either the treated water or the process residues.

### SUMMARY OF THE INVENTION

According to a first aspect thereof, the present invention provides a process for the manufacture of a chemical reagent whose principal active constituent comprises hydrated metastable forms of CAH₁₀ and C₂AH₈ in aqueous suspension, the process comprising:
a reaction stage comprising of one or more reaction vessels, at least one of which is operating at a pH in excess of pH 11.5, the reaction stage including a mixing means and further comprising;
   addition of an aqueous phase,
   addition of one or more of lime, calcium and alternative hydroxide-containing reagents
   addition of pieces of aluminium in metallic form,
   the mixing means associated with each reaction vessel being arranged to maintain each item of a solid material that is added to the vessel in continuous, semi-continuous or frequent motion with respect to inner surfaces of the vessel, materials that may be present within the vessel and with materials that may subsequently become present within the vessel; and
a particle separation stage including a separation means, or an assembly of separation means, which exploit(s) differences within particle settling velocities for achieving separation of the particles into a first product and a second product,
   the first product comprising more than 50% of CAH₁₀ particles and of C₂AH₈ particles that are precipitated within the reaction stage and of more than 50% of particles with a lower settling velocity within an accompanying aqueous phase than that of the precipitated CAH₁₀ particles and of the precipitated C₂AH₈ particles within the accompanying aqueous phase and the second product comprising more than 50% of the particles with a higher settling velocity within the accompanying aqueous phase than that of the precipitated CAH₁₀ particles and of the precipitated C₂AH₈ particles within the accompanying aqueous phase,
   a portion, up to all, of the second product being returned to the reaction stage, and
   a portion, up to all, of the first product being outputted from the process as the chemical reagent.

In an embodiment of the invention, the reaction stage may further comprise the addition of particles of abrasive material(s).

In an embodiment of the invention, the reaction stage may include oxidising means for promoting an oxidising environment.

In an embodiment of the invention the separation means may include one or more devices selected from the group comprising hydrocyclones, centrifuges, gravity separation, elutriation, screening, filtration or screw classification, or any combination of such devices.

In an embodiment of the invention adjunct materials selected from the group comprising iron hydroxides, hydrated iron oxides, hydroxides of other metals which are below aluminium within the electrochemical series, and hydrated oxides of other metals which are below aluminium within the electrochemical series, in any combination, may be added to the reaction stage.

In an embodiment of the invention a portion, up to all, of the aqueous phase that is added to the reaction stage may be sourced from the reactor(s) within which the aluminium reagent is used or from a subsequent pH reduction and/or suspended solids separation stage.

### Advantages

An advantage of the present invention is economical in that the use of machining and other processing residues from the formation, fabrication, machining and finishing processes associated with aluminium, iron and steel containing products is expected to substantially lower the operating costs for facilities employing ettringite based processes to treat high-sulphate water.

Additionally, the present invention would remove the need for easily-fouled membrane-based and/or ion exchange and/or other resin-based systems for the removal of mono-valent ions from the product water following the treatment of high-sulphate water using many of the alternative sources of aluminium reagent, in order for that water to be suitable for re-use.

### DETAILED DESCRIPTION OF THE INVENTION

The following represents non-limiting examples of preferred embodiments of the invention.

Preamble

When freshly created surfaces of metallic aluminium are exposed to wet or humid conditions, a hydrated oxide film is rapidly established on the freshly created surfaces. Initially, this hydrated oxide film consists almost entirely of a range of metastable intermediate compounds which progressively convert into more thermodynamically stable compounds. Under high pH conditions, these metastable compounds are able to dissolve into the surrounding high pH environment at a considerably higher rate than the rate that would apply to the more thermodynamically stable compounds. At ambient temperatures and at the normally preferred pH of approximately pH 11.5 for the optimum creation of ettringite whilst incurring the practical minimum of unwanted by-products, the rate of dissolution of freshly created and hydrated oxide layers on the surfaces of metallic aluminium is not very fast. However, as the pH is increased, the rate of dissolution increases rapidly. At the saturation pH for hydrated lime (approximately pH 12.5) the apparent dissolution rate is very much faster than at pH 11.5.

Typically, lime or a calcium and hydroxide containing reagent has to be added to the ettringite production stage within an ettringite based treatment process for the treatment of sulphate containing water. If prior to adding a suspension of lime and/or an alternative calcium and hydroxide containing reagent (hereinafter collectively referred to as a “Calcium and Hydroxide Suspension”) to the ettringite producing reaction stage, metallic aluminium is added to and abraded within that suspension, the above referred higher rate of dissolution of the aluminium can be achieved for the freshly formed and hydrated oxide layers that will be created on the metallic aluminium as a result of the abrasion. With appropriate control over the relative proportions of aluminium, calcium and hydroxide within the resultant suspension, a reagent can be prepared which when added in the right proportions to the ettringite production stage will enable the desired dissolved sulphate and dissolved calcium content to be achieved within the water that is produced within the ettringite production stage.

Alternatively, and preferably, the aluminium abrading process may be carried out using a smaller portion of the “Calcium and Hydroxide Suspension” in a manner which creates a higher aluminium content with respect to the desired calcium content and that a controlled and appropriately reduced quantity of the resultant “Aluminium Reagent” is added to the ettringite production stage separately or in admixture with a controlled addition of “Calcium and Hydroxide Suspension”. In this way, a greater degree of control can be achieved over the aluminium to calcium concentration ratio within the ettringite production stage. This greater degree of control can be achieved by controlling the addition process for the “Aluminium Reagent” on the basis of the dissolved sulphate concentration within the reaction product from the ettringite production reactor and by controlling the addition process for the “Calcium and Hydroxide Suspension” on the basis of maintaining the necessary pH within that reactor.

It should be noted that whilst the solubility of the aluminate ion increases rapidly as the pH is increased above pH 10, the presence of dissolved and suspended (but soluble) calcium within the “Calcium and Hydroxide Suspension” will cause much of the aluminium that is dissolved from the pieces of metallic aluminium to be precipitated as one of the metastable forms of calcium aluminate. This will cause the dissolved concentration of aluminate ions within the “Aluminium Reagent” to be substantially lower than the equilibrium solubility of aluminate ions with respect to the solution pH and with respect to the metastable hydroxides and hydrated oxides on the surface of the abraded pieces of metallic aluminium. As a result, there will be an ongoing process of removing aluminium from the surfaces of the pieces of aluminium and of precipitating that aluminium as a metastable calcium aluminate. Also, that process will be seeking to progress towards the situation where one or more of the metallic aluminium, the available calcium and the available hydroxide within the abrading mixture is exhausted.

In its metastable forms, calcium aluminate is sufficiently soluble and is able to dissolve fast enough for the precipitation of ettringite to progress rapidly, but not so rapidly as to create ettringite crystals that cannot be separated with reasonable ease from the treated water. In addition, the controlled release of calcium into the ettringite precipitation reactor that results from the dissolution of the metastable calcium aluminates is able to limit the amount of gypsum that is precipitated within those parts of the ettringite precipitation reactor where the sulphate concentration within the feed water to the reactor causes the gypsum solubility to be exceeded. When gypsum is precipitated within this reactor or when gypsum crystals accompany the feed water or other inputs to the reactor, the achievement of dissolved sulphate concentrations that are below 500 mg/l within the product water from the ettringite production reactor can be substantially hindered.

By applying the above described process logic, it is possible to create a mixture of dissolved and precipitated aluminium, the forms of which are readily available to the desired reactions within the ettringite production stage(s) of a treatment process for high-sulphate water and where the aluminium content of the mixture is not limited by the solubility of the Al(OH)₄⁻ (aluminate) ion. It is therefore preferable, but not essential, for a local stock of hydrated calcium aluminate slurry to be created and regularly/continuously replenished. This can then be used as the source for the necessary addition to the process using appropriate process controls and in a manner that is similar to one or more of the typical and well known methods for the controlled addition of lime slurry to a neutralisation process. Alternatively, some other controlled addition process could be used.

Finely divided metallic aluminium, freshly formed precipitates of hydrated oxides and aluminates can also be sourced from the many forming, shaping and surface finishing processes that are applied to the creation of aluminium based articles. These “Additional Sources” can be used to substitute a portion or all of the metallic aluminium that is subjected to the above described preparation process for a suitable “Aluminium Reagent”.

There are a number of ways by which fresh surfaces of aluminium metal can be created. The metal can be exposed to cutting, gouging, shearing, stretching or abrasion. Techniques for the creation of fine aluminium powder are also well known in the art and many of these can be undertaken in the presence of an aqueous environment or a slurry environment where the pH has been elevated or following which the pH can be elevated.

In choosing between the various options for the addition of the aluminium, cost is the principle factor. The aluminium can be added in a low-cost form, such as shredded scrap from a waste recycling activity. Any metallic impurities that may accompany this source of aluminium and which become part of the “Aluminium Reagent” can be removed using the contaminant removal capabilities of the ettringite and of any hydrated ferric oxide and ferric hydroxide that may be formed/present within the ettringite production stage.

In addition, if the benefits of Galvano Corrosion are exploited within the production process for the “Aluminium Reagent”, then a substantially smaller production unit will be needed for the creation of the reagent. These benefits can be achieved by including one or more of the following within the reaction process where the metallic aluminium is abraded and contacted with a “Calcium and Hydroxide Suspension”:—
Abrasive particles such as crushed rock, especially when the crushed rock is created from a hard rock.
Carbon particles (comprising one or more of coal, coke, graphite and other forms of elemental carbon) to provide suitable/additional cathodic surfaces.
Particles of ferric hydroxide and hydrated ferric oxide to provide additional cathodic surface area and to provide a preferential surface area for the deposit of surface fouling materials that would otherwise deposit on the surfaces of the aluminium that is being dissolved.
Particles of iron containing metal(s) to assist the abrasion processes, to provide additional cathodic surface area and to provide a source for creating particles of ferric hydroxide and hydrated ferric oxide.
A plentiful supply of air or oxygen or the controlled addition of a suitable oxidising agent to ensure the rapid conversion of the ferrous ions and the ferrous hydroxide particles that may be created by the galvanic processes into their respective ferric forms.
Adequate ventilation to ensure that any release of hydrogen is not able to reach an ignitable concentration anywhere within the process.

Typically, the mixture within the ettringite precipitation stage will contain ferric hydroxide and hydrated ferric oxide particles that have been precipitated from the high-sulphate water together with other precipitated metal hydroxide and hydrated oxide particles, including, on occasion, ferrous hydroxide particles. Except for the hydroxides and hydrated oxides of those metals which are above (more reactive than) aluminium within the electrochemical series, all of these particles will be able to assist the Galvano Coagulation processes which will assist the conversion of metallic aluminium into an “Aluminium Reagent”, especially when they are in the presence of an oxidising environment. It is therefore beneficial to utilise reaction mixture from the ettringite precipitation stage as a substitute for or in admixture with an alternative water source for the makeup water for the preparation of the “Calcium and Hydroxide Suspension”.

In order to minimize the inclusion of abrasive particles, unused metals and un-dissolved alternative aluminium source materials within the “Aluminium Reagent”, a particle segregation device may also be used to segregate and retain within or return to the “Aluminium Reagent” production reactor particles that have a higher settling velocity than the hydrated calcium aluminate particles that are created within the “Aluminium Reagent” production reactor.

During the experimental work associated with this application, it was found that when seeking to corrode metallic aluminium particles in the presence of a suspension in water of hydrated lime, the carbon cathode particles could be supplemented and/or substituted advantageously by particles of iron and/or steel and/or crushed rock, especially when the crushed rock was from a hard rock. All of these supplemental/substitutional particles appeared to provide both abrasive and cathodic functions within the dissolution process for the aluminium. This supplementation and/or substitution was advantageous when there was a plentiful supply of air to the reacting mixture, as this significantly assisted the creation of Fe(III) ions from any of the other forms of soluble iron that were present or which were created within the process. It was also found that when additional amounts of precipitated hydrated ferric oxide were present, the rate of dissolution of the metallic aluminium increased.

### BRIEF DESCRIPTION OF THE DRAWINGS

The invention will now be described in more detail, by way of example only, with reference to the accompanying FIGURE in which:

FIG. 1 shows a diagram illustrating a preferred embodiment of the process of the present invention.

The foregoing and other objects, features and advantages of the present invention will become more apparent from the following description of certain embodiments of the present invention by way of the following non-limiting example.

### EXAMPLE: SUITABLE REAGENT FOR ETTRINGITE BASED TREATMENT OF SULPHATE-RICH WATERS

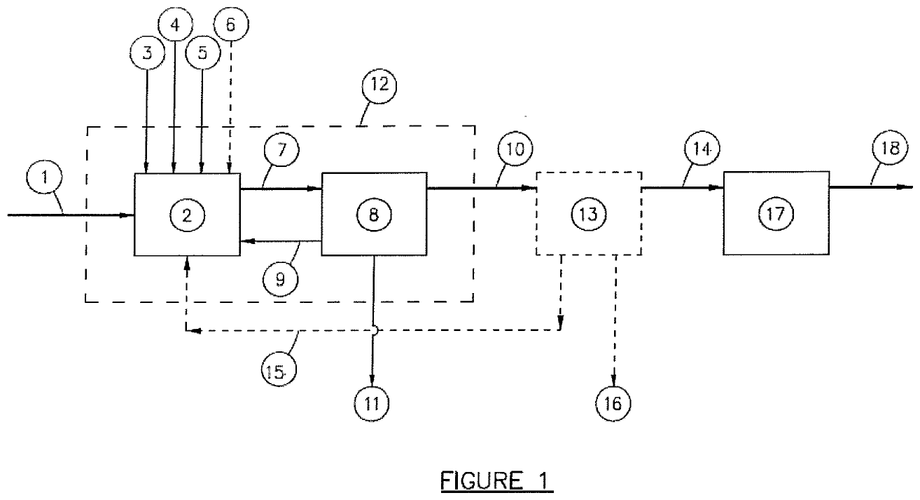

With reference to FIG. 1, the extent of the reaction stage equipment is shown diagrammatically by the dotted boundary 12. Within that boundary there is the reaction vessel or vessels 2 and the particle segregation stage 8. The particle segregation stage would be a segregation technology, a segregation device or an assembly of segregation devices selected from the list comprising hydrocyclones, centrifuges, gravity separation, elutriation, screening, filtration and screw classification,

The necessary aqueous phase for the reaction stage 12 is shown as entering the reaction vessel(s) 2 at arrow 1. Arrows 3, 4 and 5 indicate the inputs for the particles of aluminium and/or other “Additional Sources” of aluminium at 3, the lime and/or the calcium and hydroxide containing material at 4 and the abrasive at 5. The dotted arrow 6 indicates the optional addition of adjunct materials which could consist of one or more of additional abrasive material, particles of coal, particles of coke, particles of other forms of elemental carbon, particles of iron, particles of steel, ferric hydroxide, hydrated ferric oxide, ferrous hydroxide, and hydroxides and hydrated oxides of metals which are below aluminium within the electrochemical series.

The arrow 7 indicates the input flow of mixed material from the reaction vessel(s) 2 into the particle segregation stage 8. Arrow 9 indicates the return flow from the particle segregation stage of the segregated particles which include those particles which have a higher settling velocity than the calcium aluminate particles which are produced within the reaction vessel(s). Arrow 10 indicates the forward flow of particles which include calcium aluminate particles which are produced within the reaction vessel(s) and those particles which have a lower settling velocity than the calcium aluminate particles.

Arrow 11 indicate the occasional purge flows that may become necessary for purging abrasive particles which have lost their abrasiveness and for any other metallic or other impurities that may accumulate within the process as a result of contaminants, etc. within the feed materials to the process.

In some situations it may be appropriate to have an additional particle segregation stage 13 for creating an improved removal efficiency in respect of the metals, the abrasive(s) and the other reaction assisting particles from the aluminium reagent 14 and for returning them to the reaction vessel(s) 2 via stream 15. As this is an optional feature within the process it has been shown using dotted lines. Also shown in dotted lines is a purge stream 16 which would complement the occasional function of stream 11.

Vessel 17 indicates a suitable buffer storage unit for the aluminium reagent 14. This buffer storage unit is an optional but preferred feature and would be equipped with a suitable agitation arrangement to maintain in suspension the suspended particles within the reagent 14. The reagent would be forwarded to the ettringite based sulphate removal process or to wherever else it is to be used via arrow 18 on an as required basis using one or more of the many suitable feeding and metering arrangements as are well known to a skilled practitioner.

As noted above, the aqueous input 1 to the process would be preferably derived from, or downstream from the reaction stage(s) within which the aluminium reagent is used. In this way hydrated oxides and hydroxides of metals that may be present within the reaction stage where the aluminium reagent is used or which may be precipitated within subsequent neutralisation stages could be included within the input to the reaction vessel(s) 2. In particular, it is frequently the case that aluminium hydroxide will be precipitated within the neutralisation stage that would normally follow an ettringite based sulphate removal stage and the resultant concentrate of precipitated particles from a clarification stage following this neutralisation stage will enable this aluminium to be recovered into the aluminium reagent.

Also, as noted above, it is beneficial to raise the temperature within the reaction vessel(s) 2, subject to an upper temperature limit of about 50° C. Preferentially this would be achieved by preheating stream 1 before it is added to the process. However, additional heat could be added to stream 9, or by the direct introduction of steam into the reaction vessel(s) or by a heat transfer process within or through the walls of the reaction vessel(s) or by other means. From the perspective of potential scale formation, stream 9 represents the location where scale formation as a result of heat input is least likely to occur providing the heat transfer surface temperatures are maintained below about 55° C.

It should be noted that the slow conversion process of calcium aluminate from the metastable CAH₁₀ and C₂AH₈ forms into the C₃AH₆ form is also assisted by an increase in temperature. A compromise must therefore be selected between increasing the reaction rates within reaction vessel(s) 2 and minimising the conversion of the metastable calcium aluminate into the considerably less soluble C₃AH₆ form within the subsequent stages 8, 13 and 17. The selection of the optional technology that is used within stages 8 and 13 (if present) should therefore be biased towards technologies which involve a minimum residence time within stages 8 and 13. Similarly, the sizing of the buffer storage facility 17 should be on the basis of minimising the inventory that is retained within 17 subject to process control and stability considerations within the process(es) within which the aluminium reagent is to be used.

Preferably, within the reaction vessel(s) 2, the environment within the aqueous phase needs to be maintained as an oxidising environment. Subject to the design features of the reaction vessel(s), this can be achieved preferentially by maintaining a plentiful supply of ambient air within/through the vessel(s). In addition or alternatively it may be appropriate to add a compressed air sparging arrangement or a suitable oxidising agent such as hydrogen peroxide. Preferentially, if a suitable oxidising agent is to be added, it should be added to Stream 1 before Stream 1 enters the reaction vessel(s) 2.

The reaction vessel(s) 2 can be selected from a range of well-established industrial devices that will be known to a skilled practitioner. Suitable equipment could be selected from the list comprising pan mixers, Muller mixers, raked pits, rotating inclined pans, rotating drum mixers, plough share mixers, ribbon mixers, cone mixers, ball mills, autogenous mills and other similarly capable equipment.

Typically, Stream 7 will consist of a slurry with a suspended solids content within the range of 1 to 30% by weight and preferably within the range of 3 to 15% by weight. However, the process would still be effective when the suspended solids content is outside the above referred typical range.

1. A process for the manufacture of a chemical reagent whose principal active constituents comprise hydrated metastable forms of chemical compounds having the generally accepted chemical formulae Ca(Al(OH)₄)₂.6H₂O and Ca₂(Al(OH₄(OH)₂.3H₂O (or CAH₁₀ and C₂AH₈ when using Cement Industry notation) in aqueous suspension, the process comprising:
a reaction stage comprising one or more reaction vessels, at least one, of which is operating at a pH in excess of pH 11.5, the reaction stage including a mixing means and further comprising;
addition of an aqueous phase,
addition of lime and/or an alternative calcium and hydroxide containing reagent,
addition of pieces of aluminium in metal form,
the mixing means associated with each reaction vessel being arranged to maintain each item of a solid material that is added to the vessel in continuous, semi-continuous or frequent abrasive contact with respect to inner surfaces of the vessel, materials that may be present within the vessel and with materials that may subsequently become present within the vessel; and
a particle separation stage including a separation means, or an assembly of separation means which exploit(s) differences within particle settling velocities for achieving separation of particles from the reaction stage into a first product and a second product,
the first product comprising more than 50% of CAH₁₀ particles and of C₂AH₈ particles that are precipitated within the reaction stage and of more than 50% of particles with a lower settling velocity within an accompanying aqueous phase than that of the precipitated CAH₁₀ particles and of the precipitated C₂AH₈ particles within the accompanying aqueous phase,
the second product comprising more than 50% of the particles with a higher settling velocity within the accompanying aqueous phase than that of the precipitated CAH₁₀ particles and of the precipitated C₂AH₈ particles within the accompanying aqueous phase,
between zero and 100% of the second product being returned to the reaction stage, and
between 5 and 100% of the first product being outputted from the process as the chemical reagent.

2. The process of claim 1, wherein the reaction stage further comprises the addition of particles of abrasive material(s).

3. The process of claim 1, wherein the reaction stage includes oxidising means for promoting an oxidising environment.

4. The process of claim 1, wherein the separation means includes one or more devices selected from hydrocyclones, centrifuges, gravity separation, elutriation, screening, filtration and screw classification, or any combination of such devices.

5. The process of claim 1, wherein adjunct materials selected from iron hydroxides, hydrated iron oxides, hydroxides of other metals which are below aluminium within the electrochemical series, and hydrated oxides of other metals which are below aluminium within the electrochemical series, in any combination, are added to the reaction stage.

6. The process of claim 1 wherein between zero and 100% of the aqueous phase that is added to the reaction stage is sourced from the reactor(s) within which the chemical reagent is used or from a subsequent neutralisation stage that follows the reactor(s) within which the chemical reagent is used.

7. (canceled)
